(19) United States
(12) Patent Application Publication
(10) Pub. No.: US 2005/0117780 A1
(43) Pub. Date: Jun. 2, 2005

(54) Image signal processing apparatus

(75) Inventors: Tadasu Horiuchi, Yokohama (JP); Takuya Iguchi, Nishinomiya (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/944,486

(22) Filed: Sep. 13, 2004

(30) Foreign Application Priority Data
Nov. 28, 2003 (JP) 2003-398307

(51) Int. Cl. G06K 9/00; G06K 9/36; H04N 7/18

(52) U.S. Cl. 382/103; 382/107; 382/236; 348/143

(57) ABSTRACT

To selectively display image signals of plural channels and detect motion of the channels for efficient display. The present invention is a video signal switching apparatus capable of detecting motion comprising: first video signal input modules 11-1, 12-1, and 13 which input video signals of plural channels in a time division manner; first video signal storage modules 15-1 and 16-1 which store the video signals in a storage module; a video signal output module 17 which outputs video signals of plural channels stored in the video signal storage module as consecutive video signals; second video signal input modules 11-1 and 12-1 which input video signals of plural channels in a time division manner; a video signal reduction module 14 which reduces the video signals; second video signal storage modules 15-2 and 16-2 which store reduced video signals in a storage module; and a motion detection module 18 which reads out reduced video signals of different times of two or more identical channels from the second video signal storage module to detect motion and produce motion information.

### BACKGROUND OF THE INVENTION

1. Field of the Invention

The present invention relates to an apparatus that performs display, recording, and transmission while switching video signals of plural channels, and performs efficient display, recording, and transmission of video signals by detecting motion in each channel.

2. Description of Related Art

In a monitoring apparatus, to monitor many locations at the same time, a video signal switching apparatus is used to perform monitor display, recording to a recording medium, or transmission to remote locations by reducing and switching in a time division manner video signals from plural cameras. Moreover, a motion detection apparatus is used to efficiently monitor plural video signals.

An image encoding apparatus that compressively encodes images to record or transmit plural video signals at the same time is proposed (see JP-A No. 28755/2001). This apparatus comprises: a motion vector detection section; a compression method control section; and an image compression section, wherein the motion vector detection section detects motion vectors, the compression method control section finds a total sum of the magnitudes of motion vectors of each multiplexed image, and determines a correlation with an image of an immediately preceding frame from the total sum value to control a compression method, and the image compression section compressively encodes image data according to the control of the compression method, thereby increasing encoding efficiency.

Also, a supervisory video signal recording apparatus is proposed (see JP-A No. 62409/1994). According to this apparatus, video signals outputted from plural video cameras are inputted to two switchers so that the output of one switcher is outputted to a frame memory circuit and a comparison circuit. The comparison circuit makes a comparison with a signal of an immediately preceding frame that passed through the frame memory circuit. When a motion discriminating circuit detects motion of images, an input switching circuit that has detected a video camera photographing moving images controls another switcher and a discriminating signal adding circuit to add a discriminating signal corresponding to the video camera to moving video signals, thereby recording only signals from the video camera photographing the moving images. As a result, the supervisory video signal recording apparatus can efficiently perform monitoring.

Furthermore, the following technique is proposed in JP-A No. 55621/1999, for example. In a monitoring system that records video images while switching plural cameras, at the same time as recording to a recording medium such as a hard disk drive (HDD), the same video images as recorded in the HDD or the like, video images switched in different timing, or compressed video images are outputted to a different recording apparatus to enable backup recording.

### SUMMARY OF THE INVENTION

The number of concurrently monitoring cameras has been increasing recently, and there is a known method by which the number of image frames produced per second is decreased depending on monitoring locations to increase recording or transmission efficiency. However, to detect motion for all inputted video signals by the above-mentioned prior art, it is necessary to reduce all plural video signals with the same frequency before detecting motion, and therefore, for example, when the number of video signals increases, it is difficult to increase encoding efficiency.

In one embodiment of the present invention, a video signal input section for motion detection aside from video input for displaying, recording, or transmitting video signals is provided so that motion of plural video signals is always detected independently. With this construction, video signals can be efficiently displayed, recorded, or transmitted.

According to one embodiment of the present invention, since motion of video signals of plural channels can be always detected independently of display, recording, or transmission of the video signals, the video signals can be efficiently displayed, recorded, or transmitted.

### BRIEF DESCRIPTION OF THE DRAWING

These and other features, objects and advantages of the present invention will become more apparent from the following description when taken in conjunction with the accompanying drawings wherein:

FIG. 1 is a block diagram of an apparatus in a first embodiment of the present invention;

FIG. 2 is a block diagram of an apparatus in a second embodiment of the present invention; and

FIG. 3 is a block diagram of an apparatus in a third embodiment of the present invention.

### DETAILED DESCRIPTION OF PREFERRED EMBODIMENTS

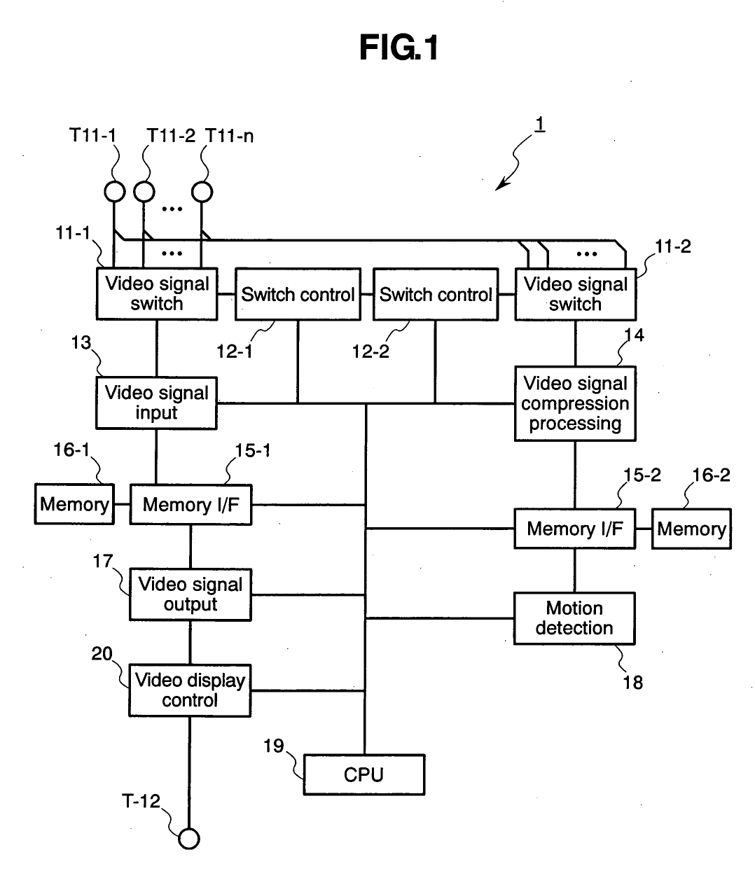

A first embodiment of the present invention will be described using FIG. 1. A video signal switching apparatus 1 according to the first embodiment of the present invention comprises: a first video signal switch 11-1; a second video signal switch 11-2; a first switch control section 12-1; a second switch control section 12-2; a video signal input section 13; a video signal reduction processing section 14; a first memory interface section 15-1; a second memory interface section 15-2; a first memory section 16-1; a second memory section 16-2; a video signal output section 17; a motion detection section 18; a CPU 19; a video display control section 20; plural video signal input terminals T11-1 to T11-n; and a video signal output terminal T12.

The first video signal switch 11-1, controlled by the CPU 19, selects and outputs signals of plural channels. The first switch control section 12-1, controlled by the CPU 19, controls the operation of the first video signal switch 11-1 to switch input signals of plural channels in a time division manner. The video signal input section 13, controlled by the CPU 19, sends a video signal from the first video signal switch 11-1 to a first video signal storage module. The first video signal switch 11-1, the first switch control section 12-1, and the video signal input section 13 together form a first video signal input module to selectively input video signals of plural channels in a time division manner.

The first memory interface section 15-1 and the first memory section 16-1, controlled by the CPU 19, together form a first video signal storage module that records video signals from the first video signal input module in the storage module (the first memory section 16-1).

The video signal output section 17, controlled by the CPU 19, forms a video signal output module that outputs video signals of plural channels stored in the first video signal storage module as consecutive video signals.

The second video signal switch 11-2 and the second switch control section 12-12 are controlled by the CPU 19. The second video signal switch 11-2 selectively outputs signals of plural channels. The second switch control section 12-12, which serves as a module for controlling the operation of the second video signal switch 11-2, selects input signals of plural channels in a time division manner. The second video signal switch 11-2 and the second switch control section 12-2 together form a second video signal input module that selectively inputs video signals of plural channels in a time division manner.

The video signal reduction processing section 14, controlled by the CPU 19, forms a video signal reduction module that performs reduction processing for a video signal from the second video signal input module and outputs the resulting signal to the second memory interface section 15-2.

The second memory interface section 15-2 and the second memory section 16-2, controlled by the CPU 19, together form a second video signal storage module that records a reduced video signal from the second video signal input module in the storage module (the second memory section 16-2).

The motion detection section 18, controlled by the CPU 19, forms a motion detection module that compares video signals of different times of an identical video channel read from the second video signal storage module, and finds the difference of the video signals and outputs motion information to the CPU 19.

The CPU 19 controls the operation of the sections that configure the video signal switching apparatus 1, as well as the operation of the entire apparatus.

The video display control section 20 forms a video signal display control module that converts video signals of plural channels into video signals displayable on a monitor. The video display control section 20, controlled by the CPU 19, displays an alarm mark in a video signal of a channel in which motion has been detected by the motion detection section 18, displays video signals of channels in which motion has been detected by the detection section 18, more largely than video signals of other channels, and displays video signals of channels in which motion has been detected by the detection section 18, with a greater display frequency than video signals of other channels.

Video signals of plural channels inputted from the image input terminals T11-1 to T11-n are guided to the first video signal switch 11-1 controlled by the first switch control section 12-1. The CPU 19 controls the first switch control section 12-1 so that a desired display rate is obtained for each of the inputted video channels. The video signals switched in a time division manner in the first video signal switch 11-1 are guided to the video signal input section 13, and stored in the first memory section 16-1 through the first memory interface section 15-1. The memory addresses in which the video signals are stored are controlled by the CPU 19. The video signal output section 17 reads out the stored video signals from the first memory section 16-1 and outputs them as successive video signals so that a desired display rate is obtained for each of the video channels. The video display control section 20 inputs the video signals from the video signal output section 17, reduces or switches a video signal of each channel according to the control of the CPU 19, performs processing necessary for video display such as addition of synchronous signals, and then outputs the video signals to the video signal output terminal T12.

On the other hand, video signals of plural channels inputted from the image input terminals T11-1 to T11-n are also guided to the second video signal switch 11-2 controlled by the second switch control section 12-2. The CPU 19 controls the second switch control section 12-2 to successively switch the inputted image channels. The video signals switched in a time division manner in the video signal switch section 10-2 are guided to the video signal reduction processing section 14. The video signal reduction processing section 14 thins out or smoothes the inputted video signals in vertical and horizontal directions to create a reduced image having a predetermined number of pixels. The reduced video signals produced thus are stored in the second memory section 16-2 through the second memory interface section 15-2. The memory addresses in which the video signals are stored are controlled by the CPU 19. The motion detection section 18 compares video signals of different times of an identical video channel, finds the difference of the video signals, and outputs motion information to the CPU 19.

The CPU 19, according to the motion information from the motion detection section 18, controls the video display control section 20 to display an alarm mark in a video signal of a channel in which motion has been detected. Also, the CPU 19, according to the motion information from the motion detection section 18, controls the video display control section 20 so that a video signal of a channel in which motion has been detected is largely displayed on a monitor. Moreover, the CPU 19, according to the motion information from the motion detection section 18, controls the first switch control section 12-1, the video signal input section 13, the first memory interface section 15-1, the video signal output section 17, and the video display control section 20 so that a video signal of a channel in which motion has been detected is displayed on a monitor at a high display rate.

According to the first embodiment, motion of video signals of all channels can be detected independently of video display, and the video display can be controlled in accordance with detected motion. Therefore, a channel in which motion has been detected may be indicated to an observer by displaying an alarm mark in the video display of the channel, the channel may be preferentially largely displayed, or the channel may be displayed at a higher display rate.

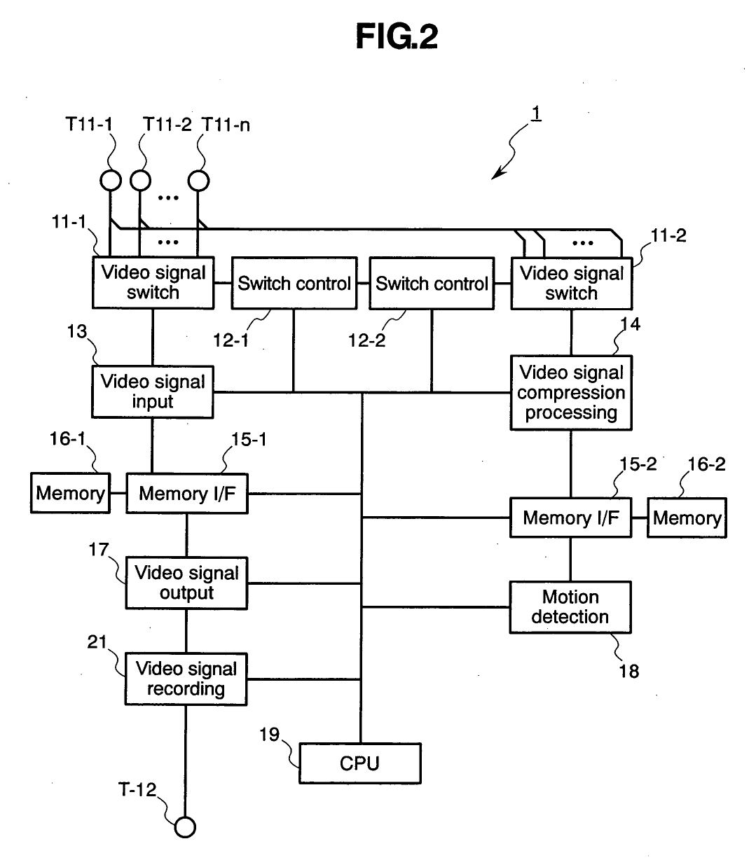

Next, a second embodiment of the present invention will be described with reference to FIG. 2. In FIG. 2, a video signal recording section 21 is provided in place of the video display control section 20 in FIG. 1. It is understood that other sections shown in FIG. 2 that are identical to sections shown in FIG. 1 are identified by the same reference numbers. In the second embodiment, the operation of the same sections as in the first embodiment is omitted from the description below.

The video signal recording section 21 admits a video signal from the video signal output section 17, compressibly encodes the video signal according to the control of the CPU 19, and records the compressed video signal in a recording medium. The video signal recording section 21, controlled by the CPU 19, forms a video signal recording module that compressibly encodes video signals of plural channels and records the compressed video signals in a recording medium. The video signal recording section 21 records video signals of a channel in which motion has been detected by the motion detection module, at a lower compression rate than video signals of other channels, or records information indicating that the motion detection module has detected motion.

The CPU 19, according to the motion information from the motion detection section 18, controls the video signal recording section 21 to record channels in which motion has been detected, and time information in a recording medium. The CPU 19, according to the motion information from the motion detection section 18, controls the first switch control section 12-1, the video signal input section 13, the first memory interface section 15-1, the video signal output section 17, and the video signal recording section 21 so that a video signal of a channel in which motion has been detected is recorded in a recording medium with high resolution or at a high frame rate.

According to the second embodiment, motion of video signals of all channels can be detected independently of video recording, and a compressive encoding method at the time of recording can be controlled according to detected motion. Therefore, video signals of channels in which motion has been detected can be recorded in a recording medium with a higher resolution or at a higher recording rate. Or motion detection information as well as the video signals can be recorded in a recording medium.

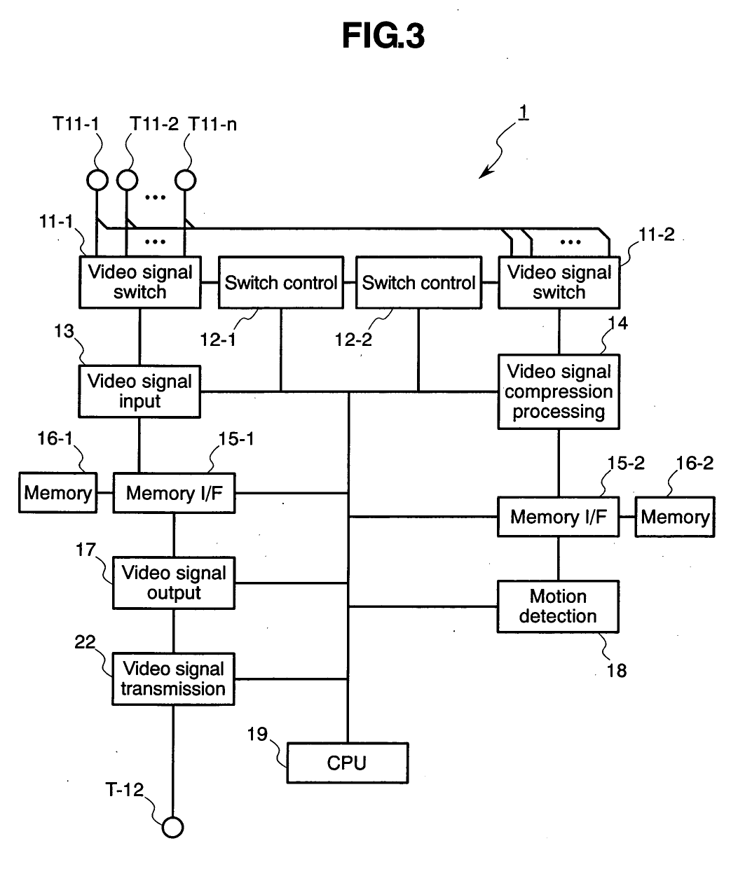

Next, a third embodiment of the present invention will be described with reference to FIG. 3. In FIG. 3, a video signal transmission section 22 is provided in place of the video display control section 20 in FIG. 1. It is understood that other sections shown in FIG. 3 that are identical to sections shown in FIG. 1 are identified by the same reference numbers. In the third embodiment, the operation of the same sections as in the first embodiment is omitted from the description below.

The video signal transmission section 22 admits a video signal from the video signal output section 17, and according to control from the CPU 19, compressibly encodes the video signal and transmits the compressed video signal to other apparatuses (e.g., a monitoring section, a centralized supervisory room, etc.) not shown through a network not shown. The video signal transmission section 22, controlled by the CPU 19, functions as an image signal transmission module that compressibly encodes video signals of plural channels and transmits the compressed video signals. The video signal transmission section 22, controlled by the CPU 19, functions as a video signal transmission module that compressibly encodes video signals of plural channels and transmits the compressed video signals. The video signal transmission section 21 transmits video signals of a channel in which motion has been detected by the motion detection module, at a lower compression rate than video signals of other channels, or transmits information indicating that the motion detection module has detected motion.

The CPU 19, according to the motion information from the motion detection section 18, controls the video signal transmission section 22 to transmit an alarm signal indicating that motion has been detected, or channels in which motion has been detected, and time information. The CPU 19, according to the motion information from the motion detection section 18, controls the first switch control section 12-1, the video signal input section 13, the first memory interface section 15-1, the video signal output section 17, and the image record transmission section 119 so that video signals of channels in which motion has been detected are transmitted with a high resolution or at a high frame rate.

According to the third embodiment, motion of video signals of all channels can be detected independently of video transmission, and a compressive encoding method at the time of transmission can be controlled according to detected motion. Video signals of channels in which motion has been detected can be transmitted with a higher resolution or at a higher transmission rate.

According to the first to third embodiments, since inputted video signals of plural channels are selected in a time division manner for motion detection. Therefore, as many motion detection sections as there are channels need not be provided, contributing to reduction in apparatus costs. Since a reduced image is used for motion detection, a necessary memory capacity can be reduced in comparison with a case of performing operations for all pixels, and the circuit size of a detection section or processing time can be reduced.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. A video signal switching apparatus for detecting motion, comprising:
a first video signal input module which receives video signals from plural channels in a time division manner;
a first video signal storage module coupled to the first video signal input module for storing video signals from the first video signal input module;
a video signal output module which supplies video signals of the plural channels stored in the first video signal storage module as consecutive video signals;
a second video signal input module which receives video signals from the plural channels in a time division manner;
a video signal compression module coupled to the second video signal input module for compressing the video signals from the second video signal input module;
a second video signal storage module which stores compressed video signals from the video signal compression module; and
a motion detection module which reads out compressed video signals of different times of two or more identical channels from the second video signal storage module to thereby detect motion and produce motion information.

2. The video signal switching apparatus of claim 1 further, comprising:
a video signal display control module which converts video signals of the plural channels into video signals displayable on a monitor, and
displaying an alarm mark in a video signal of a channel in which motion has been detected by the motion detection module.

3. The video signal switching apparatus of claim 1 further comprising:
a video signal display control module which converts video signals of the plural channels into video signals displayable on a monitor, and
displaying a video signal of a channel in which motion has been detected by the motion detection module, in a magnified manner in comparison to the video signals of other channels.

4. The video signal switching apparatus of claim 1 further comprising:
a video signal display module which converts video signals of the plural channels into video signals displayable on a monitor, and
displaying a video signal of a channel in which motion has been detected by the motion detection module, with a greater display frequency in a comparison to the video signals of other channels.

5. The video signal switching apparatus of claim 1 further comprising:
a video signal recording module which compressively encodes video signals of the plural channels and records the compressed video signals on a recording medium, and
recording a video signal of a channel in which motion has been detected by the motion detection module, at a lower compression rate than video signals of other channels.

6. The video signal switching apparatus of claim 1 further comprising:
a video signal recording module which compressively encodes video signals of the plural channels and records the compressed video signals on a recording medium, and
recording information indicating that the motion detection module has detected motion in the video signal recording module.

7. The video signal switching apparatus of claim 1 further comprising:
a video signal transmission module which compressively encodes video signals of the plural channels and transmits the compressed video signals, and
transmitting a video signal of a channel in which motion has been detected by the motion detection module, at a lower compression rate than video signals of other channels.

8. The video signal switching apparatus of claim 1 further comprising:
a video signal transmission module which compressively encodes video signals of the plural channels and transmits the compressed video signals, and
transmitting information indicating that the motion detection module has detected motion.
